(19) United States
(12) Patent Application Publication
(10) Pub. No.: US 2005/0248512 A1
(43) Pub. Date: Nov. 10, 2005

(54) Matrix display device with energy recovery circuit

(76) Inventors: Fransiscus Jacobus Vossen, Eindhoven (NL); Remco Los, Eindhoven (NL); Adrianus Sempel, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/527,009

(22) PCT Filed: Jul. 31, 2003
(86) PCT No.: PCT/IB03/03740

§ 371 Date: Mar. 7, 2005

(30) Foreign Application Priority Data
Sep. 10, 2002 (EP) 02078731.3

(51) Int. Cl. G09G 3/30

(52) U.S. Cl. 345/76

(57) ABSTRACT

Matrix display device having row electrodes (4) and column electrodes (5), an intersection of a row and a column electrode defining a pixel cell (1) having a pixel cell capacitance (8), and drive circuits (2,3). Blind energy used for charging the pixel cell capacitances (8) when driving the pixel cells (1) is not dissipated but stored into a buffer capacitor (6) through an inductor (7) forming a series inductor-capacitor circuit and subsequently recovered by discharging the buffer capacitor (6) into the pixel cell capacitances (8) through a current source (13). Energy recovery is thus current driven, which allows to control the light reflected or emitted by the pixel cell (1) in a manner which is less dependent on temperature variations and/or ageing of the device.

### FIELD OF THE INVENTION

The invention relates to a matrix display device having row and column electrodes—an intersection of a row and a column electrode defining a pixel cell having a pixel cell capacitance—and drive circuits including means for discharging at least partially the pixel cell capacitance through an inductor into a buffer capacitor, thereby storing energy from the pixel cell capacitance into the buffer capacitor.

The invention also relates to a method for driving such a matrix display device.

The invention applies particularly to organic electroluminescent display devices such as Organic LED (OLED) and PolyLED (PLED) displays and the like used for personal computers, television sets, mobile devices and so forth.

### DESCRIPTION OF THE PRIOR ART

Such matrix display devices are well known in the art. Because of the mainly capacitive character of their pixel cells, quite some blind energy is involved in driving the device. Several solutions have been developed in the past in order to recover this blind energy instead of dissipating it.

In particular, EP0548051 discloses an energy recovery circuit for a matrix display device which includes means for discharging a pixel cell capacitance through an inductor into a buffer capacitor, thereby storing energy which was previously used for charging the pixel cell capacitance when driving the pixel cell. The stored energy is subsequently recovered by discharging the buffer capacitor through the inductor back to the pixel cell capacitance for driving the pixel cell.

Though such known display devices generally work well, they present temperature drift problems and long-term time drift (ageing) problems, which negatively influences image quality.

### SUMMARY OF THE INVENTION

It is an object of the invention to provide a matrix display device which presents an improved image stability over temperature and over time. The invention is defined by the independent claims. The dependent claims define advantageous embodiments.

To this end, the matrix display device according to the invention is characterized in that the drive circuits include means for discharging at least partially the buffer capacitor, through a means for controlling an amount of electrical charge, into the pixel cell capacitance, thereby recovering at least partially the stored energy.

In the prior art display devices, the buffer capacitor is discharged through the inductor into the pixel cell capacitance without passing through a means for controlling an amount of electrical charge. Though in theory this poses no problems of temperature drift or of ageing, in reality these components as well as their interconnections and also the row and column electrodes are not ideal and do have characteristics which change with temperature and with time. Since the pixel cell is voltage-driven during the discharge of the buffer capacitor, a change in temperature for instance will provoke a change in discharge current and as a result will introduce an unwanted change in the light output of the pixel cell. The same problem occurs with ageing of the known devices.

In the display device according to the invention, the discharge of the buffer capacitor into the pixel cell capacitance occurs through a means for controlling an amount of electrical charge. During the discharge of the buffer capacitor, the pixel cell will thus receive a controlled amount of charge and, as a consequence, temperature drift and/or ageing of the components and/or their interconnections will have a reduced influence on the light output of the pixel cell.

Preferably, the means for controlling an amount of electrical charge is a current source. Using a current source is indeed a simple way for controlling the amount of charge flowing into the pixel cell.

In a further preferred embodiment, the matrix display device according to the invention includes means for delivering power from a power supply to the pixel cell through the current source. This allows indeed the pixel cell to be fully current-driven, whether it is during a normal driving phase of the pixel cell, i.e. a phase whereby energy is drawn from the power supply into the pixel cell, or during an energy recovery phase, i.e. the phase as explained above where energy is drawn from the buffer capacitor into the pixel cell capacitance. The advantage being that the same current source can be used for both the normal driving and for the energy recovery, resulting in simplifications and cost reductions.

Most preferably, the matrix display device according to the invention includes means for connecting the bottom of the buffer capacitor either to ground or to substantially half the voltage of the power supply.

This permits indeed to almost completely discharge the pixel cell capacitance and therefore to store a maximum of energy into the buffer capacitor.

The matrix display device according to the invention is preferably of the organic luminescent type (such as for example Organic LED [OLED] or PolyLED [PLED] types) because with this type of devices the light output is highly dependent on the current through the pixel cell, whereas the voltage-versus-light characteristic of the pixel cell shows a much stronger variation with variations in temperature and lifetime.

### SHORT DESCRIPTION OF THE DRAWINGS

These and further aspects of the invention will be explained in greater detail by way of example and with reference to the accompanying drawings in which:

FIG. 1 shows a schematic representation of a matrix display device;

FIG. 2 shows a known energy recovery circuit for the matrix display device of FIG. 1;

FIG. 3 shows an energy recovery circuit for a matrix display device according to the invention;

FIG. 4 shows a preferred matrix display device according to the invention;

FIGS. 5a, 5b and 5c show an exemplary circuit diagram for a part of the matrix display device of FIG. 4;

FIG. 6 shows waveform diagrams useful in understanding the operation of the display device of FIG. 5;

FIG. 7 shows an exemplary circuit diagram for an NxM matrix display device according to the invention.

The figures are schematic and are not drawn to scale. Generally, identical components are denoted by the same reference numerals in the Figures.

### DETAILED DESCRIPTION OF PREFERRED EMBODIMENTS

According to a first aspect, the invention concerns a matrix display device.

FIG. 1 shows schematically a matrix display device having row electrodes (4) and column electrodes (5) as well as corresponding driver circuits: a column driver circuit (2) for the column electrodes (5) and a row driver circuit (3 ) for the row electrodes (4). Each intersection of a row electrode (4) and a column electrode (5) defines a pixel cell (1), which may be of various types depending on the way it reflects or produces light (liquid crystal, electroluminescent, plasma discharge, etc . . .). The complete set of pixel cells is thus arranged in a two dimensional matrix, suitable for displaying an image. For the sake of simplification, this description will be based on a monochrome LED type display, i.e. a display device where each pixel cell is constituted of a single LED. It will be clear that the invention can equally be applied to other types of displays as well as to color displays.

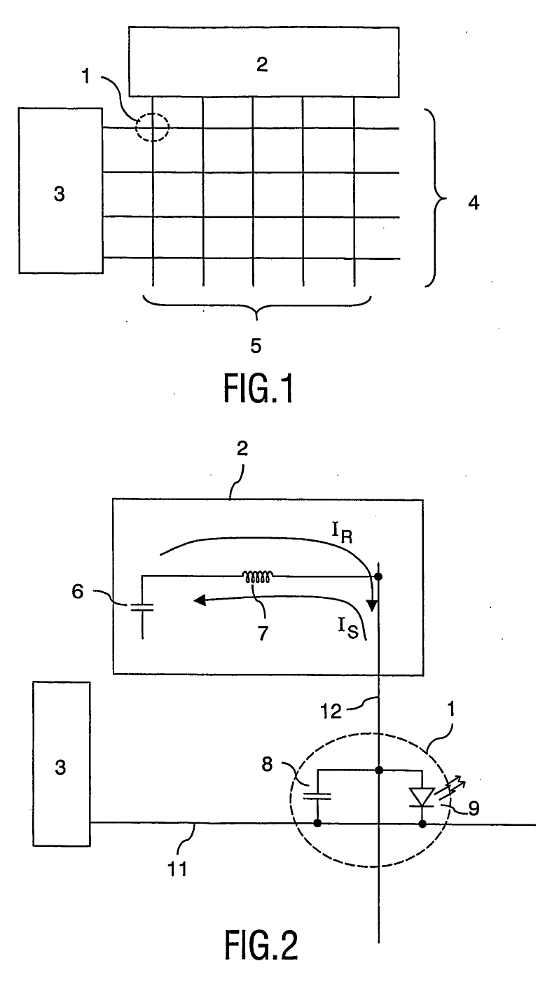

In this exemplary case, as shown in FIG. 2, a pixel cell (1) thus comprises a LED (9) whose anode is connected to a column electrode (12) and whose cathode is connected to a row electrode (11). When the column driver circuit (2) applies a voltage to the column electrode (12) and the row driver circuit (3) applies a lower voltage to the row electrode (11), the LED (9) will generate light. By driving the pixels of the matrix display device according to an image signal, such as for example a video signal, an image will be displayed by the device.

Because of the mainly capacitive character of a pixel cell (1), quite some blind energy is involved in driving the display device. This needlessly increases power consumption and consequently power dissipation. With a proper energy recovery circuit, blind power dissipation may be strongly reduced. Several energy recovery circuits are known from the prior art, and an example thereof is illustrated in FIG. 2. Here, a pixel cell (1) is shown which comprises one LED (9) and a pixel cell capacitance (8) which is substantially constituted of the parasitic capacitance formed by the overlapping row electrode (11) and column electrode (12) at their intersection as well as the intrinsic capacitance of the LED (9). In the drawings, the pixel cell capacitance is symbolized by a capacitor 8. When driving the pixel cell (1) by applying for instance a positive voltage to the column electrode (12) and ground to the row electrode (11), the pixel cell capacitance (8) will be charged and the LED (9) will generate light. Subsequently the pixel cell capacitance (8) is discharged into a buffer capacitor (6) through an inductor (7), as indicated by the current I_{S} in FIG. 2, i.e. through a series resonant LC circuit. An amount of energy is thereby transferred from the pixel cell capacitance (8) to the buffer capacitor (6). When the pixel cell (1) is to be driven again, the process is reversed: the buffer capacitor (6) discharges through the inductor (7) into the pixel cell capacitance (8), as indicated by the current I_{R} in FIG. 2. The energy stored previously is thereby, at least partially, recovered.

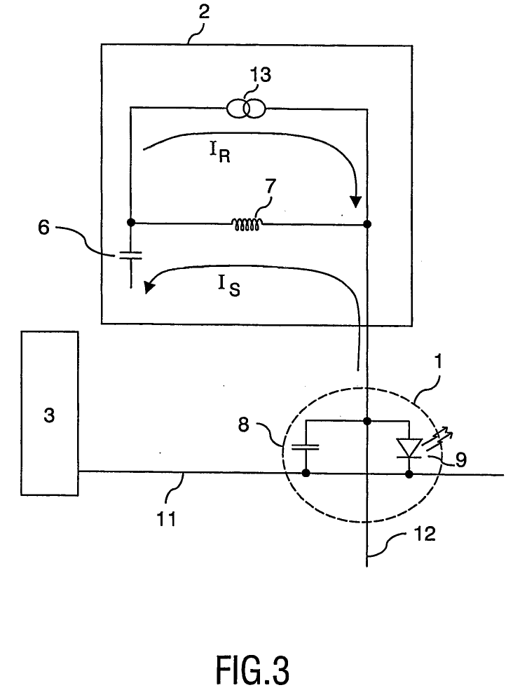

In a matrix display device according to the invention, the pixel cell capacitance (8) is discharged in substantially the same way. The energy recovery occurs however in a different way, as can be seen from FIG. 3, which shows schematically an energy recovery circuit for a matrix display device according to the invention. Here, the buffer capacitor (6) does not discharge into the pixel cell capacitance (8) through the inductor (7), but rather through circuitry for controlling an amount of electrical charge, in this example a current source (13), as indicated by the current I_{R} in FIG. 3.

During the discharge of the buffer capacitor (6), the pixel cell (1) will thus be current-driven. Drive current and light output of a LED are almost linearly related, and hence temperature drift and/or ageing of the components and/or their interconnections will have a reduced influence on the light output of the pixel cell (1). In the prior art, the pixel cell (1) is voltage-driven during energy recovery. A change in temperature will—among other things—introduce a change in the current through the LED (9) and therefore the light output of said LED (9) will change too. With a display device according to the invention, this problem is considerably reduced.

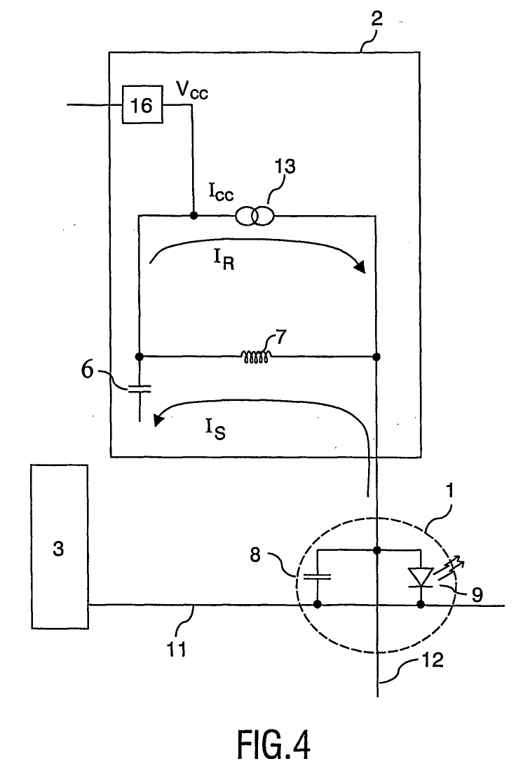

Next, a power supply (16), as shown in FIG. 4 is considered, the power being used for turning the pixel cell (1) on or off, in the present example for turning the LED (9) on or off.

In a preferred embodiment of the invention, the matrix display device includes circuitry for delivering power from the power supply (16) to the pixel cell (1) through the current source (13), as shown in FIG. 4. Thus, in operation, a power supply current I_{CC} , will flow from the power supply (16), through the current source (13) and into the pixel cell (1) for turning the LED (9) on. Hence, in this preferred embodiment, the LED is fully current-driven, whether power comes from the power supply (16) or from the energy recovery circuit (from the buffer capacitor (6)), which results in an even better image stability in function of temperature and/or time. A further advantage of this preferred embodiment is that the same current source (13) can be used for both the normal driving and the energy recovery, resulting in simplifications and cost reductions.

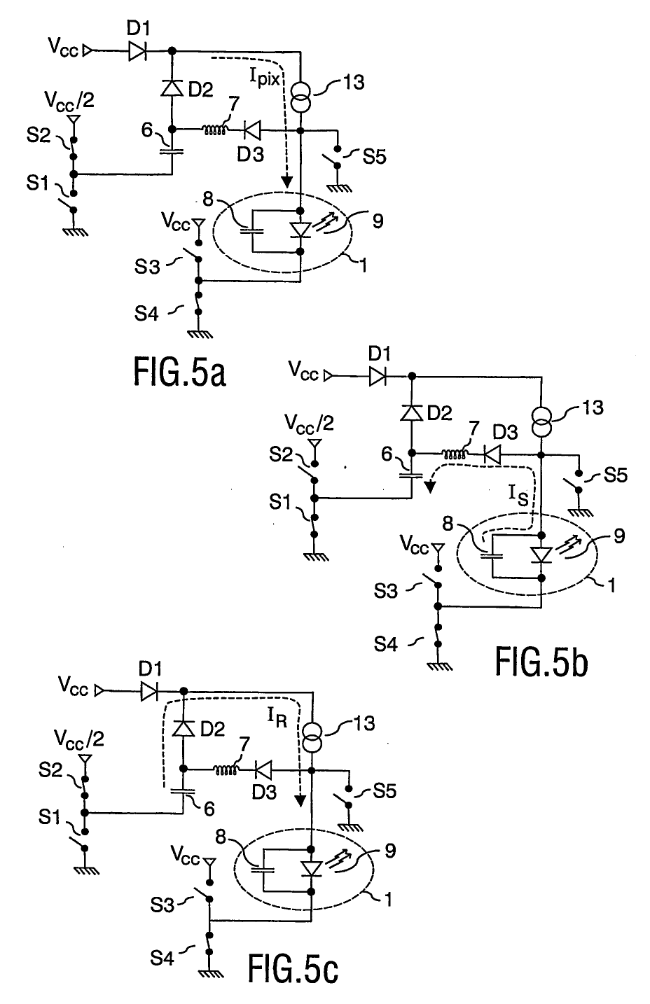

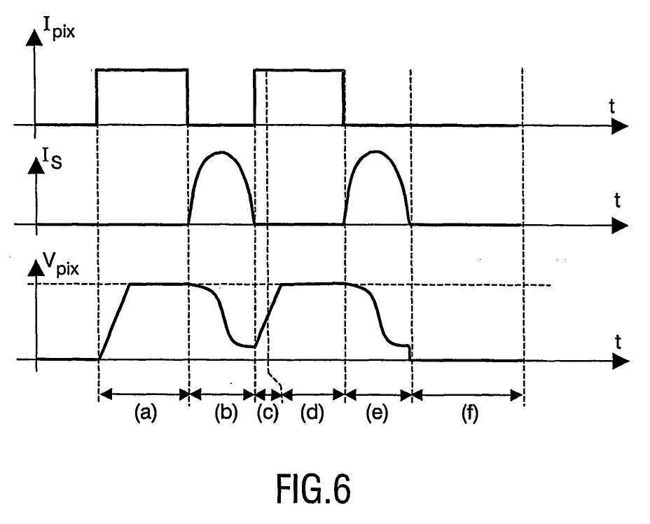

In FIGS. 5a,b,c are shown various phases of operation of an exemplary circuit of a matrix display device according to the invention. In FIG. 6 are shown waveform diagrams as a function of time t, which are useful in understanding the operation of the display device of FIG. 5. For the sake of simplicity, only one pixel cell (1), in this case comprising a LED (9), is shown. The power supply (16) has a voltage V_{CC}.

FIG. 5a shows a first phase during which the LED (9) is driven so as to generate light. Switches S1, S3 and S5 are open and switches S2 and S4 are closed. Hence, power from the power supply (16) (indicated in FIG. 5 by V_{cc} ) is supplied to the LED (9) through the current source (13), so that the current I_{PIX} flowing through the pixel cell (1) is constant and the voltage V_{PIX} across the pixel cell capacitance (8) increases almost linearly until it reaches a voltage Vₚ that is determined by the current through the LED (9) (bias point of diode), as shown in part (a) of the waveform diagrams in FIG. 6.

FIG. 5bshows a subsequent phase for storing the energy of pixel capacitor (8) into buffer capacitor (6). During this subsequent phase, switches S2, S3 and S5 are open and switches S1 and S4 are closed. Hence, the pixel cell capacitance (8), the inductor (7) and the buffer capacitor (6) form a series resonant circuit. A sinusoidal current I_{S} will thus flow from the pixel capacitance (8) through the inductor (7) and into the buffer capacitor (6), thereby increasing the voltage across the buffer capacitor (6) by an amount of delta_V. After a certain number of cycles the voltage across the buffer capacitor (6) will reach V_{cc}/2. In the next energy recovery cycle the voltage across the buffer capacitor (6) will become V_{cc}/2+delta_V. Concurrently, the voltage V_{PIX} across the pixel cell capacitor (8) decreases following a cosine shape. When the current I_{S} crosses zero after half a period of the sine wave, diode D3 will block, preventing the current from flowing back into the pixel capacitance (8) and putting an end to this subsequent—also called energy storage—phase. At this time, the pixel cell capacitance (8) is almost completely discharged. A small residual charge may nevertheless be present due to losses in the circuit. Waveform diagrams corresponding to this subsequent phase can be seen in part (b) in FIG. 6.

FIG. 5cshows a further phase for recovering the energy previously stored in the buffer capacitor (6) by discharging it back into the pixel capacitance (8). During this further phase, switches S1, S3 and S5 are open and switches S2 and S4 are closed. The voltage at the terminal of the buffer capacitor (6) connected to the inductor (7) is at that moment V_{CC}/2+V_{CC}/2+delta_V=V_{CC}+delta_V. Diode D2 will therefore conduct and diode D1 will block. A current I_{R} will flow from the buffer capacitor (6) through the current source (13) and into the pixel cell capacitance (8). In other terms, buffer capacitor (6) will discharge into pixel capacitance (8) in a current-controlled manner and the voltage across pixel capacitance (8) will increase almost linearly during this further phase. Waveform diagrams of this further phase—also called energy recovery phase—can be seen in part (c) in FIG. 6. As soon as the stored energy is recovered, i.e. when the voltage at the mentioned terminal of the buffer capacitor (6) gets below a certain level, D2 will block and D1 will conduct, so that the power supply (16) takes over the supply for the LED (9). The voltage V_{PIX} across the pixel cell (1) will continue to increase almost linearly since power continues to be supplied via the current source (13), until it reaches the LED bias point V_{P} , after which the voltage Vₚᵢₓ will remain constant as can be seen in part (d) in FIG. 6. The voltage across the buffer capacitor (6) will again be stabilized at approximately V_{CC}/2, which corresponds to the situation of the first phase, and the circuitry is thus ready for the next energy recovery cycle. Part (e) in FIG. 6 shows another energy storage phase.

If the pixel cell (1) is next to be turned off, it is advantageous to completely discharge C_{PIX} after the energy storage phase. This can for example be achieved by closing S5. Hence, the pixel cell capacitance (8) discharges rapidly, as can be seen in part (f) in FIG. 6.

It will be clear for the person skilled in the art that the switches shown in these and other figures will in a real circuit mostly be solid state switches such as, but not limited to, Bipolar, FET, MOS, MOSFET or IGBT transistors or any combination of these. In the example of FIG. 5, S1, S4 and S5 are for instance NMOS transistors with their source terminal connected to ground; S2 is for instance a PMOS transistor with its source terminal connected to V_{CC}/2, and S3 is for instance a PMOS transistor with its source terminal connected to V_{CC}.

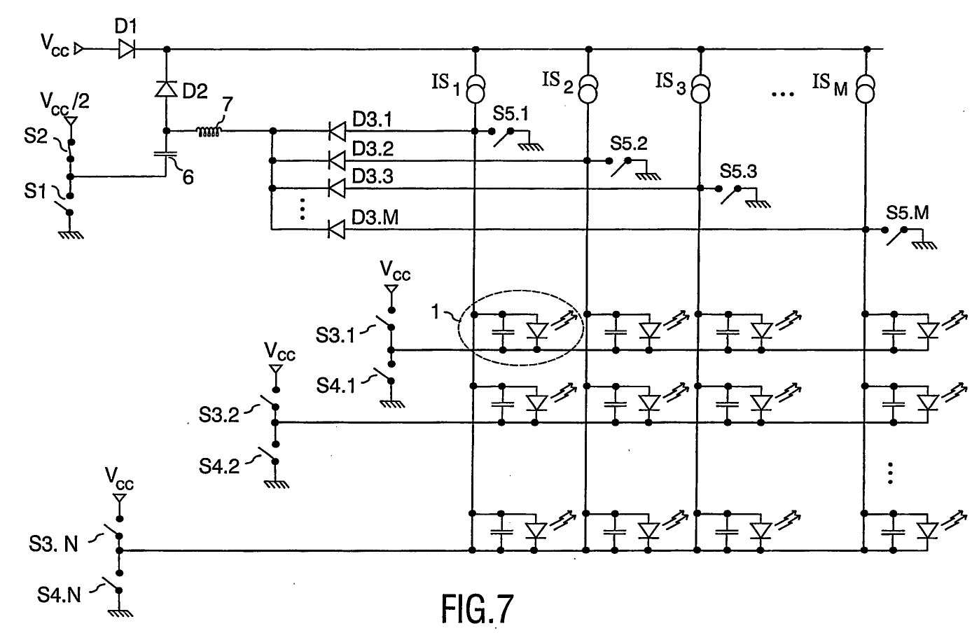

FIG. 7 shows a more complete picture of an exemplary matrix display device according to the invention and serves to illustrate how the energy recovery circuit of FIGS. 5a, 5b and 5c works in the case of a display device having N row electrodes and M column electrodes, thus MxN pixel cells.

As one can notice, the same energy recovery circuit is represented, except that the M column electrodes are connected to M diodes D_{3.1} to D_{3.M} and that the cathodes of said diodes are all tied together and connected to the inductor (7). The function of these diodes is equivalent to the function of D3 in FIG. 5. For displaying an image on such a display device, the rows are selected from top to bottom by applying ground in a scanning fashion to the row electrodes. This is achieved by closing the switches S_{4.1} (i standing for the number of the row to be scanned) in a scanning fashion. To drive pixels on selected rows, current is forced in the corresponding columns by means of M current sources IS₁ to IS_{M} , one for each column. For a selected row, energy from all pixel cells of this row which were turned on as well as energy from all pixel cells in the corresponding columns is stored into the buffer capacitor (6) during a storage time period, according to the principles explained in connection with FIG. 5b. Upon selecting a subsequent row, the energy stored into the buffer capacitor (6) is recovered and feeds the pixel cells which are to be turned on in said subsequent row during a recovery time period, according to the principles explained in connection with FIG. 5c. Thereafter, the display device is again ready for selecting a further row.

Such exemplary M*N matrix display device according to the invention thus has a very simple energy recovery circuit. The energy recovery circuit is essentially constituted of two switches S1 and S2 (the other switches being required anyhow for driving the display panel without energy recovery), one buffer capacitor (6), one inductor (7) and M+2 diodes (D_{3.1} to D_{3.M} , D1, D2).

Furthermore, the additional voltage—delta_V—created across the buffer capacitor (6) during the energy storage phase is to be kept as small as possible in order not to impose too large voltage variations on the power line (line going from D1 to the current sources IS₁ to ISₘ in FIG. 7) during the energy recovery phase. This can be achieved by using a large buffer capacitor (6). On the other hand, there is a wish to minimize the space occupied by said buffer capacitor (6), particularly in view of the current trend to reduce the thickness of display devices. A good compromise is thus to be found. This has been achieved by keeping delta_V between one tenth and one hundredth of the power supply voltage V_{cc}. Because all the non-selected rows are connected to V_{CC} via switches S3.N, the recovery circuit has to deal with the capacitance of a complete column for every pixel cell in the selected row that has to be discharged (the complete display capacitance if all pixels are ON in a row) during one row time. During one frame (N rows), the complete display capacitance has to be charged and discharged N times if all pixel cells in the display are ON. Therefore, in a preferred embodiment of the display device according to the invention, the buffer capacitor (6) has a value between 10 and 100 times the sum of the pixel cell capacitances of all pixel cells of the display device.

In short, the invention may be described as follows:

matrix display device having row electrodes (4) and column electrodes (5)—an intersection of a row and a column electrode defining a pixel cell (1) having a pixel cell capacitance (8)—and drive circuits (2,3). Blind energy used for charging the pixel cell capacitances (8) when driving the pixel cell (1) is not dissipated but stored into a buffer capacitor (6) through an inductor (7) forming a series inductor-capacitor circuit and subsequently recovered by discharging the buffer capacitor (6) into the pixel cell capacitances (8) through a current source (13). Energy recovery is thus current driven, which allows to control the light reflected or emitted by the pixel cell (1) in a manner which is less dependent on temperature variations and/or ageing of the device.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. Matrix display device having row electrodes (4) and column electrodes (5), an intersection of a row and a column electrode defining a pixel cell (1) having a pixel cell capacitance (8), and drive circuits (2, 3) for driving the row electrodes (4) and the column electrodes (5) including means for discharging at least partially the pixel cell capacitance (8) through an inductor (7) into a buffer capacitor (6), thereby storing energy from the pixel cell capacitance (8) into the buffer capacitor (6), characterized in that the drive circuits (2, 3) include means for discharging at least partially the buffer capacitor (6) through a means for controlling an amount of electrical charge (13) into the pixel cell capacitance (8), thereby recovering at least partially the stored energy.

2. Matrix display device according to claim 1, characterized in that the means for controlling an amount of electrical charge (13) flowing into the pixel cell capacitance (8) is a current source.

3. Matrix display device according to claim 2, the display device further having a power supply (16) adapted to deliver power to the pixel cell (1) through the current source (13).

4. Matrix display device according to claim 3, characterized in that the buffer capacitor (6) has one terminal connected to the inductor (7) and another terminal connected either to ground or to substantially half the voltage of the power supply (16).

5. Matrix display device according to claim 1, characterized in that the buffer capacitor (6) has a capacitance which is comprised between 10 and 100 times the sum of the pixel cell capacitances of all pixel cells of the display device.

6. Matrix display device according to claim 1, characterized in that the display device is of the organic luminescent type.

7. Method of driving a matrix display having row electrodes (4) and column electrodes (5), an intersection of a row and a column electrode defining a pixel cell (1) having a pixel cell capacitance (8), the method including a first step of discharging at least partially the pixel cell capacitance (8) through an inductor (7) into a buffer capacitor (6), characterized in that the method includes a further step of discharging at least partially the buffer capacitor (6) through a means for controlling an amount of electrical charge (13) flowing into the pixel cell capacitance (8).

8. Method of driving a matrix display device according to claim 7, characterized in that the means for controlling an amount of electrical charge (13) flowing into the pixel cell capacitance (8) is a current source.

9. Method of driving a matrix display device according to claim 8, the display device further having a power supply (16) adapted to deliver power to the pixel cell (1) through the current source (13).
